(19) United States
(12) Patent Application Publication
(10) Pub. No.: US 2026/0338338 A1
(43) Pub. Date: Oct. 29, 2026

(54) OPTICAL MODULE FOR A LIGHT-EMITTING SYSTEM FOR A MOTOR VEHICLE

(71) Applicant: VALEO VISION, Bobigny (FR)

(72) Inventors: Benoit DELANDE, Bobigny (FR); Pierre RENAUD, Bobigny (FR)

(73) Assignee: VALEO VISION, Bobigny (FR)

(21) Appl. No.: 19/113,537

(22) PCT Filed: Sep. 21, 2023
(86) PCT No.: PCT/EP2023/076121

§ 371 Date: Mar. 20, 2025

(30) Foreign Application Priority Data
Sep. 21, 2022 (FR) 2209550

(51) Int. Cl. F21S 41/24; F21S 41/153; F21S 41/47; F21S 41/663; F21W 103/60

(52) U.S. Cl. CPC F21S 41/24; F21S 41/153; F21S 41/47; F21S 41/663; F21W 2103/60

(57) ABSTRACT

The invention relates to an optical module for a light-emitting system for an automotive vehicle. The optical module includes at least one light source, a one-piece primary optical system including at least one primary optical member. The primary optical member being arranged to form a primary image from the light source. A mask placed downstream of the primary optical member and having at least one opaque zone and a window formed in the opaque zone. The window being arranged facing the primary optical member so as to form a secondary image from the primary image, a segment of the one-piece primary optical system extending through the window; and a projecting optical system arranged to project, onto the ground, the secondary image formed by the mask.

### TECHNICAL FIELD

The invention relates to the field of light-emitting automotive vehicle systems. More precisely, the invention relates to an optical module for a light-emitting system for an automotive vehicle.

### BACKGROUND OF THE INVENTION

In the field of automotive lighting and light-based signaling, it is known to perform, in addition to conventional functions, functions allowing logos or luminous patterns to be projected onto the ground, in the vehicle's near field. This type of function may for example be used in the context of driver assistance, for example to produce a marking on the ground allowing a traffic lane to be indicated. This type of function may also be used to enhance a conventional signaling function, in order to warn another road user of a change of path.

In order to project the luminous pattern or logo onto the ground, one known solution consists in introducing dark regions into a pixelated light beam emitted by a light-emitting system of the automotive vehicle, the driver or road user thus seeing the pattern or logo through the contrast between the dark and bright regions. However, this solution requires the light beam to have a particularly high resolution and therefore requires a particularly high number of light sources, which makes the light-emitting system expensive and complex.

Another known solution consists in collecting the light emitted by a plurality of light sources, via light guides, then in projecting images of the exit faces of these light guides onto the ground, via a projecting optical system. Although this solution is satisfactory from the point of view of efficiency and simplicity, it does not however allow complex patterns to be formed on the ground without multiplying the number of light sources and light guides. Moreover, the sharpness of the patterns that are projected onto the ground may be reduced, as a result of the complexity of production of light guides by injection-molding of plastic and of the presence of an exit optical member to which all the light guides are joined in order to allow their integration into an optical module and the thickness of which may thus have an impact on the optical performance of this optical module.

Another known solution consists in adding to the preceding solution an opaque mask provided with windows or transparent zones, making it possible to form, from the images formed by the guides, new images, which are projected by a projecting optical system. However, this solution requires an additional optical part to be used, and therefore the size, the cost and the complexity of production of the optical module to be increased. Furthermore, although the light guides allow light beams of small aperture to be obtained, this aperture remains larger than the dimensions of the windows or transparent zones of the mask, and hence a substantial amount of the light emitted by the light sources is intercepted by the mask, which significantly decreases the efficiency of the module. Further-more, it is not possible to decrease the dimensions of the light guides, in particular with a view to configuring them to achieve a short focal length and/or high resolution, because of the complexity of production of these light guides when it is desired to manufacture them by injection molding. Lastly, in the case where the mask is made of glass, Fresnel re-flections may occur between the mask and the exit of the light guides, or even between the mask and an optical system provided downstream of the mask, which further decreases the efficiency of the module.

There is thus a need for a compact optical module, capable of efficiently projecting a luminous pattern or logo onto the ground, that would allow a complex pattern to be produced from a single light source, for example a pattern having details within the pattern itself or a pattern composed of a number of disconnected sub-patterns, and/or that would improve the sharpness of the pattern projected onto the ground.

### SUMMARY OF THE INVENTION

The present invention falls within this context and aims to meet these needs.

To these ends, one subject of the invention is an optical module for a light-emitting system for an automotive vehicle, comprising:
a. at least one light source;
b. a one-piece primary optical system comprising at least one primary optical member, said primary optical member being arranged to form a primary image from said light source;
c. a mask placed downstream of said primary optical member and having at least one opaque zone and a window formed in the opaque zone, said window being arranged facing said primary optical member so as to form a secondary image from the primary image, a segment of the one-piece primary optical system extending through the window;
d. a projecting optical system arranged to project, onto the ground, the secondary image formed by the mask.

In the invention, the light rays emitted by the light source are deflected by the primary optical member so as to form a primary image. It may be a question of a virtual image or of a real image, which may substantially correspond to a magnification of the image of the emission surface of the light source or rather be a distorted image of this emission surface. It will be noted that most of the light rays emitted by the light source, or even almost all thereof, can thus be collected by the primary optical member to form the primary image. It will moreover be understood that, because part of the primary optical system passes through the mask, the mask may be positioned in the immediate vicinity of the zone of the primary optical member where this primary image is formed. This improves the efficiency and compactness of the optical module. The light rays may thus pass through the window in the mask, so that the primary image is converted by the mask into a secondary image. The window may thus define an outline or pattern in the primary image, to form the secondary image. This secondary image, or a combination of the primary image and of the secondary image, may thus be projected onto the ground by the projecting optical system. The fact that it is the secondary image that is projected by the projecting optical system in particular makes it possible to obtain a pattern on the ground the outlines of which have a satisfactorily sharpness, independently of the manufacturing quality of the primary optical member.

In the present invention, the luminous pattern formed by projecting the secondary image onto the ground using the projecting optical system may form a logo, a pictogram, a geo-metric pattern or a set of a plurality of logos, pictograms or geometric patterns or a combination thereof, for example a pictogram associated with one or more geometric pat-terns.

In the invention, the expression “opaque zone” is understood to mean a zone capable of intercepting a ray of light and completely preventing transmission of this ray of light through the mask. The mask can advantageously be formed by a thin plate made of an opaque material and provided with slots or cutouts allowing the one or more windows to be produced.

Advantageously, the or each window is arranged facing the primary optical member so as to define, partially or completely, an outline of the primary image and/or to define a pattern within the primary image, for example by defining an outline of said pattern by means of an opaque zone partially or completely encircling a window or by defining said pattern negatively by means of an opaque zone arranged within a window. In other words, the defined outline of the primary image and/or the pattern defined within the primary image thus defines the secondary image.

In one embodiment of the invention, the primary optical system may be produced by over-molding at least one material on the mask. In other words, during the over-molding of the primary optical system, material penetrates into the or each window of the mask. In this case, it is ensured that the mask can be placed in the immediate vicinity of the zone of the primary optical member where the primary image forms, the secondary image thus forming on the primary image. The primary optical system will potentially be made by over-molding the same polymer or a plurality of polymers of the same index. By “same polymer”, what is meant is that the primary optical members and the exit optical member are made from materials that are at least produced from the same base polymer, for ex-ample polycarbonate (or PC) or PMMA or even silicone. However, these materials may have different fillers.

Advantageously, the projecting optical system has a focal surface passing substantially through the mask or located substantially between the primary optical member and the mask. For example, said focal surface may be a plane or a curved surface located substantially level with a wall downstream of the mask. In the case where the secondary image is entirely defined by the mask, a projecting optical system focused on the mask will thus be able to be provided in order to project the secondary image having sharp edges onto the ground. In the case where the secondary image is defined by the mask and by the primary optical member, a projecting optical system focused on the junction between the primary optical member and the mask will thus be able to be provided in order for the projecting optical system to project a combination of the primary image and of the secondary image onto the ground, this combination having sharp edges.

Preferably, the projecting optical system and the mask are arranged so that the secondary image projected onto the ground by the projecting optical system is entirely bounded by substantially sharp edges.

In the invention, by “an image projected onto the ground has a substantially sharp edge” what is meant is that the variation in the illumination on the ground caused by this projection, between two points located on either side of this edge in a direction substantially perpendicular to the edge and separated by at least 1 cm, has a slope, in particular at least at one point, greater than or equal to 10 lux/cm.

In one example of embodiment of the invention, the projecting optical system is arranged to project the secondary images onto the ground in the vehicle's near field. By near field, what is meant is a projection distance of less than 10 meters and in particular of less than 5 meters and/or an overall projection direction making an angle of at least 5°below the horizontal and in particular of at least 10° below the horizontal. These images may thus contribute to performance of a function indicating a path being followed by the vehicle, in particular a function such as a direction indicator or reversing light.

Provision could be made for the optical module to comprise a single primary optical member.

In one alternative embodiment of the invention, the optical module comprises a plurality of selectively controllable light sources. Where appropriate, the one-piece primary optical system comprises a plurality of primary optical members, each primary optical member is arranged to form a primary image from one of said light sources, and the mask includes a plurality of windows each arranged facing one of the primary optical members so as to form a secondary image from the primary image formed by that primary optical member, one segment of the one-piece primary optical system extending through each of the windows.

Advantageously, the primary optical members are arranged in a matrix array. In other words, the primary optical members are arranged adjacent to one another, to form rows and columns, and in particular so that the entrance and exit faces are organized in a matrix array while being spaced apart from one another by a constant pitch.

In one embodiment of the invention, the primary optical system comprises an exit optical member, said primary optical member comprising an entrance face for light, facing which said light source is placed, and a junction face joining the primary optical member to said segment extending through said window, said segment being joined to the exit optical member. In other words, said segment forms a linking segment between the primary optical member and the exit optical member.

It will be understood that, in this embodiment, the primary optical system is a one-piece part over-molded on the mask, which lies between the junction face of the primary optical member and the exit optical member, while being contiguous to the junction face of the primary optical member and to an upstream face of the exit optical member. The efficiency and opacity of the optical module is thus improved.

Provision may in particular be made for the exit optical member to define a receptacle, in said upstream face, within which the mask lies.

Advantageously, the exit optical member has a smooth, substantially dome-shaped exit face. For example, the exit optical member may be a spherical frustum or, as a variant, a cylindrical frustum. This feature allows the exit optical member to perform a function correcting the geometric aberrations introduced by the projecting optical system during projection of said images of the junction faces onto the ground.

Where appropriate, provision may be made for the junction face of the primary optical member, or indeed of each primary optical member, and an upstream face of the mask to lie substantially in the same plane.

In one embodiment of the invention, said primary optical member comprises a primary light guide, the entrance face of said light guide being joined to the junction face of said light guide by an envelope such that each point on the outline of the entrance face is connected to one point on the outline of the junction face by a straight line.

According to this feature, the light emitted by a light source through the entrance face of a primary light guide may propagate through the primary light guide via total internal reflection from the walls of the light guide to the junction face. The fact that the envelope is a developable surface makes it possible to form, at the junction face, a pattern that is entirely defined by substantially sharp edges, which pattern forms the primary image and may then be converted by the mask.

For example, the entrance face of the or each primary light guide may be substantially rectangular, and the junction face of the or each primary light guide may have a substantially different shape from that of the entrance face of said primary light guide, and in particular from those of the exit faces of the other primary light guides. As a variant, for example in the case of a matrix-array arrangement, the entrance faces of the primary light guides may all be identical and the exit faces of the primary light guides may all be identical.

Preferably, the projecting optical system has a focal surface passing substantially through the junction face where said primary optical member joins the segment.

According to one example of embodiment of the invention, the primary optical system comprises a plurality of primary optical members joined to the exit optical member by linking segments, in such a way that the junction faces of at least two adjacent primary optical members, and the linking segments joined to these junction faces, are spaced apart from one another.

According to one example of embodiment of the invention, the optical module comprises at least two light sources each placed facing one entrance face of one of the primary optical members, to which it belongs. Provision may be made for the number of light sources to be less than the number of primary optical members, one or more primary optical members then not having a light source. As a variant, provision may be made for at least one light source to be placed facing the entrance face of each primary optical member. It should be noted that this feature thus makes it possible to define a standard primary optical element, usable whatever the overall pattern that it is desired to project onto the ground, and that only the number of sources and the profile and number of zones of the mask are then defined depending on this overall pattern. At least one of the patterns of this overall pattern will then be defined by the mask.

Where appropriate, the mask comprises a plurality of windows, each of which is passed through by one of the linking segments, the mask lying between the junction faces and the exit optical member.

In another embodiment of the invention, the primary optical system may not have an exit optical member provided downstream of the mask. In this case, the primary optical system will solely comprise one or more primary optical members arranged upstream of the mask, a segment of the primary optical system extending from each primary optical member through a window of the mask to define an exit face for light of the primary optical system.

Preferably, the or each selectively controllable light source comprises a light-emitting semi-conductor chip, in particular a light-emitting diode. Still preferably, each selectively controllable light source is able to emit white-colored light. As a variant, each selectively controllable light source is able to emit amber-colored light. Again as a variant, each selectively controllable light source is able to emit light the color of which is controllable.

Advantageously, the projecting optical system comprises at least one lens and/or at least one reflector and/or a combination of at least one lens and of at least one reflector.

Preferably, the projecting optical system may comprise a single projecting lens the focal surface of which passes substantially through the mask. As a variant, the projecting optical system may comprise a substantially planar mirror arranged so as to form virtual images of said secondary image on one side of the substantially planar mirror and a projecting lens located on the other side of the substantially planar mirror and the focal surface of which passes substantially through these virtual images. This type of projecting optical system makes it possible to substantially reduce the bulk of the optical module.

Another subject of the invention is a light-emitting system for an automotive vehicle, comprising an optical module according to the invention.

Advantageously, the light-emitting system may comprise a unit for controlling the light sources of said optical module.

For example, said light-emitting system may comprise a light-emitting device such as an automotive vehicle tail lamp and/or automotive vehicle front headlamp, and/or a light-emitting device arranged in a fender of an automotive vehicle and/or in a rear-view mirror of an automotive vehicle, the optical module being arranged in this light-emitting device.

Advantageously, the control unit is able to selectively control each of the light sources of said optical module, depending on an instruction received from a computer of the automotive vehicle.

For example, the control unit may be arranged, depending on a first instruction received from a computer of the automotive vehicle, to control the emission of light by a first group of light sources of the optical module and, depending on a second instruction received from a computer of the automotive vehicle, to control the emission of light by a second group of light sources of the optical module, the second group comprising at least one light source not belonging to the first group.

According to one example, the light-emitting system may comprise an additional optical module comprising at least one additional light source and able to emit a signaling light beam, which is in particular regulatory, and the control unit may be arranged, depending on an instruction received from a computer of the automotive vehicle, to control, in a synchronized manner, said additional light source of the additional optical module and said light sources of the optical module.

### BRIEF DESCRIPTION OF DRAWINGS

The present invention will now be described using examples that are merely illustrative and in no way limit the scope of the invention, and with reference to the appended drawings, in which drawings the various figures show:

FIG. 1 schematically and partially, a cross-sectional view of an optical module according to one embodiment of the invention;

FIG. 2 schematically and partially, a perspective view of a mask of the module of FIG. 1;

FIG. 3 schematically and partially, a perspective view of the primary optical element of the module of FIG. 1; and FIG. 4 schematically and partially, a light-emitting system for an automotive vehicle according to one embodiment of the invention and incorporating the optical module of FIG. 1.

### DETAILED DESCRIPTION OF THE INVENTION

In the following description, elements that are identical, in structure or function, and that appear in more than one figure, have been designated by the same reference signs, unless otherwise indicated.

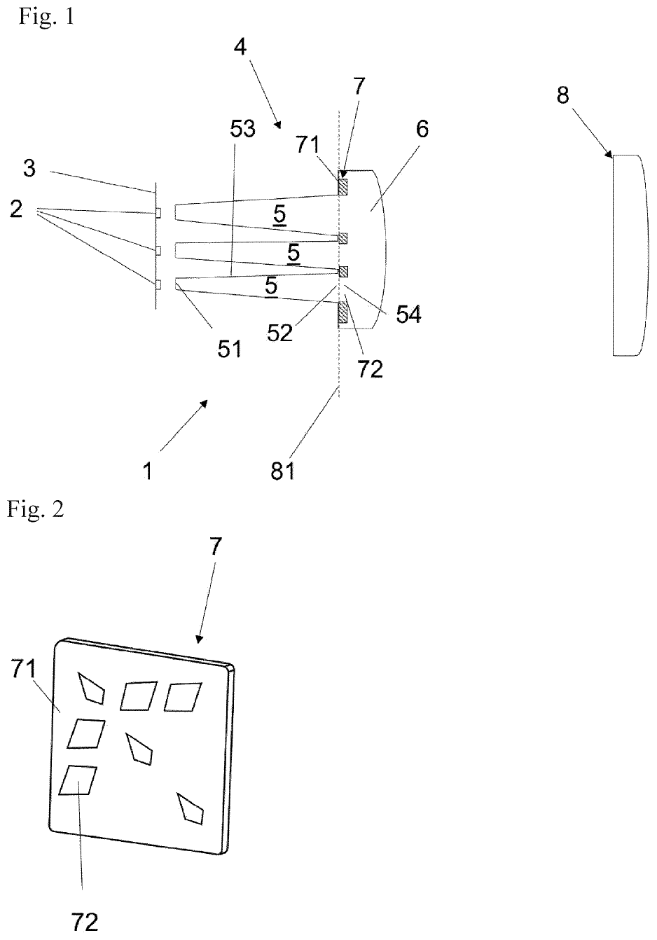

FIG. 1 shows an optical module 1 for a light-emitting system for an automotive vehicle according to a first embodiment of the invention.

The optical module 1 comprises a plurality of light-emitting diodes 2 mounted on the same printed circuit board 3. In the described example, the optical module 1 comprises three LEDs 2 that are each able to be controlled independently of the others to emit yellow-or amber-colored light.

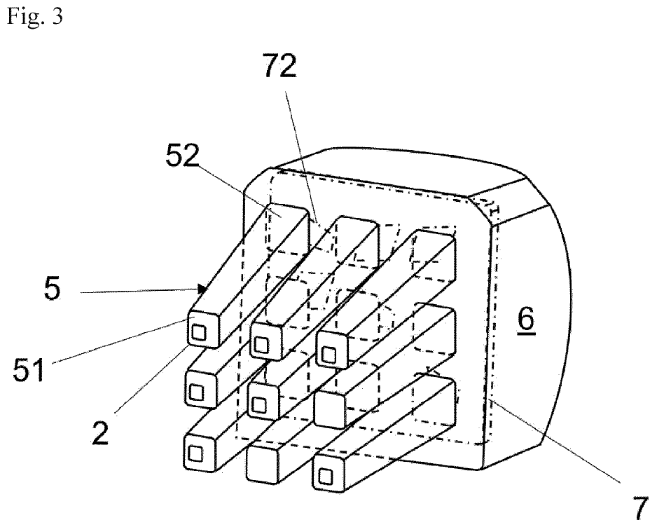

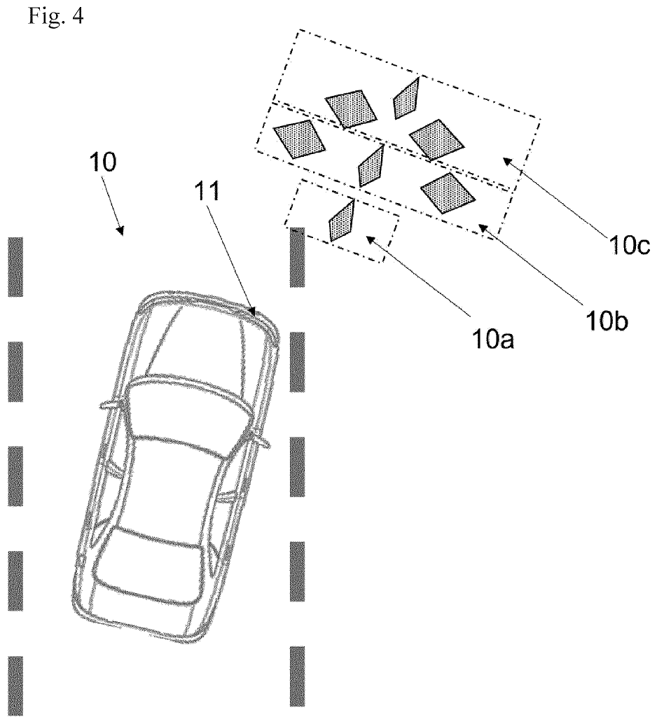

The optical module 1 comprises a primary optical system 4, taking the form of a one-piece optical part 4 arranged downstream of the light-emitting diodes 2. This primary optical system 4 will be described with reference to FIG. 2 and FIG. 3, which show a rear perspective view of this part 4.

The primary optical system 4 comprises a plurality of primary optical members 5 and an exit optical member 6 to which the primary optical members 5 are joined. In the described example, the primary optical element 4 comprises nine primary optical members 5, each taking the form of a light guide. The primary optical members 5 are arranged in a matrix array, in three rows and three columns.

The optical module comprises a mask 7 placed within the one-piece part 4, downstream of the primary optical members 5. In the described example, the mask 7 is formed by a plate 71 made of an opaque material, in which holes have been produced, each defining a window 72 of predetermined shape. This mask has been shown in perspective in FIG. 2. It will be noted that the profiles of each window 72 may be distinct from one another.

The primary optical system 4 is a one-piece part, the light guides 5 and the exit optical member 6 being manufactured from the same material, namely polycarbonate or PC or silicone. In the described example, the primary optical system 4 was produced by over-molding this material on the mask 7. During the over-molding, material thus penetrated in-to the windows 72 of the mask 7 to define segments 54 each joining one of the light guides 5 to the exit optical member 6. In other words, the refractive indices of the light guides 5, of the segments 54 and of the exit optical member 6 are identical, and there are no dioptric interfaces at the junctions between these various portions of the primary optical system 4, and hence light passing through the primary optical system 4, from the light guides 5 to the exit optical member 6, undergoes no deflection, and particularly no reflection at these junctions, which allows the efficiency of the optical module to be increased by 10%.

Each light guide 5 has an entrance face 51, facing which one of the LEDs 2 is placed, any light emitted by this LED 2 thus penetrating into the light guide 5 via the entrance face 51.

Each light guide 5 is joined to one of the segments 54 by a junction face 52, which is located opposite the entrance face 51 and on an upstream wall of the mask 7. More precisely, the primary optical system 4 has been over-molded on the mask 7 so that the junction faces 52 and the upstream wall of the mask 7 lie in the same plane.

For each light guide 5, the entrance face 51 is joined to the junction face 52 by an envelope 53. This envelope 53 is a developable surface, and hence each point on the outline of the entrance face 51 is connected, via the envelope 53, to one point on the outline of the junction face 52 by a straight line. Any light emitted by the LED 2 located facing the entrance face 51 is thus coupled to the light guide 5, when it penetrates into this light guide 5 via this entrance face 51, and propagates via successive total internal reflections against the envelope 53 to the junction face 52, via which it is decoupled from the light guide 5 and penetrates into the segment 54 then into the exit optical member 6. The junction face 52 thus forms an imaginary exit face of the light guide 5.

The junction face 52 of a light guide 5 thus defines, by virtue of its outline, a pattern the shape of which is predetermined and specific to the light guide 5. The shape of the entrance face 51 and the envelope 53 of each light guide 5 thus makes it possible to exploit all the light emitted by an LED 2 through the entrance face 51 so as to obtain, at the junction face 52, a pattern that is entirely defined by substantially sharp edges. Likewise, the shape of the entrance face 51 and the envelope 53 make it possible to obtain a uniform distribution of light inside the pattern, at the junction face 52.

In other words, each light guide 5 is arranged to form an image, called the primary image, from the light source 2 placed facing its entrance face 51, at its junction face 52, and therefore at the upstream face of the mask 7. The edges of each primary image are defined by the edges of each junction face 52. Moreover, the light guides 5 are arranged such that two adjacent junction faces 52 are spaced apart.

It will be noted that in the example of FIG. 3, the entrance faces 51 are all similar, as are the junction faces 52. In other words, the primary image obtained at the junction face 52 of a light guide 5 is identical for all the light guides 5, regardless of their position in the ma-trix array. It is thus possible to obtain, at the mask 7, a matrix array of primary images that are identical to one another. The presence or absence of an LED facing the entrance faces 51 and/or activation or deactivation of the LEDs placed facing the entrance faces 51 alone define(s) the matrix array of primary images. Thus, in the example in FIG. 3, only seven LEDs have been provided. In other words, two light guides 5 have no light source level with their entrance face 51.

It is possible to imagine shapes other than those described, and in particular a semi-circular shape, a rhombus shape or a deformed rectangular shape, without departing from the scope of the present invention. Likewise, it is possible to imagine all the shapes of the entrance faces being distinct from one another or indeed the dimensions of only some or all the entrance faces being distinct from one another or indeed the orientations of only some or all the entrance faces being distinct from one another, without departing from the scope of the present invention. Likewise, the junction faces of the light guides may be distinct from one another.

Each window 72 of the mask 7 lies facing a junction face 52 of a light guide 5 facing which a light source has been placed. In other words, each window 72 makes it possible to redefine an outline in the primary image formed at the junction face 52 facing which it is arranged, thus forming a secondary image. The perimeter of each window 72 therefore de-fines the outline of each secondary image. It will be noted that, for the two light guides 5 without a light source, only an opaque zone lies facing their junction faces 52.

In the described example, the exit optical member 6 has a smooth, substantially dome-shaped exit face.

The optical module 1 comprises a projecting optical system 8. In the example of FIG. 1, the projecting optical system 8 is a projecting lens 8 having a focal plane 81 passing substantially through the upstream face of the mask 7.

This projecting lens 8 is thus arranged to project, onto the ground, in a near field, the secondary images formed by the mask 7. The patterns projected onto the ground then have outlines defined by the perimeter of the windows 72, which are thus entirely defined by sharp edges in the images projected onto the ground, after inversion by the projecting lens 8.

FIG. 4 illustrates a light-emitting system 10 for an automotive vehicle according to one example of embodiment of the invention.

The light-emitting system 10 comprises a front headlamp 11. The optical module 1 in FIG. 1 is arranged in the front headlamp 11.

The light-emitting system 10 comprises a control unit (not shown) that receives instructions from a computer of the automotive vehicle with a view to performing light-emitting functions, and that controls the LEDs 2 of the optical module 1 depending on these instructions.

On receipt of an instruction to emit a function of the sequential-turn-indicator type, which instruction is for example generated by the computer when the automotive vehicle is changing lane, the control unit controls the LEDs 2 cyclically. For example, in a cycle, the control unit activates the bottom right LED 2, the optical module 1 thus projecting onto the ground, in the vehicle's near field, the image 10a formed by the mask 7 from the junction face 52 of the corresponding light guide 5. The control unit then activates the LEDs 2 on the diagonal, the optical module 1 thus projecting, onto the ground, in the vehicle's near field, the image 10b formed by the mask 7 from the junction faces 52 of the corresponding light guides 5, the preceding LED 2 remaining activated. The control unit then activates the remaining LEDs 2, the optical module 1 thus projecting, onto the ground, in the vehicle's near field, the image 10c formed by the mask 7 from the junction faces 52 of the corresponding light guides 5, the preceding LEDs 2 remaining activated. Lastly, the control unit deactivates all the LEDs 2.

It will thus be understood that the optical module 1 thus performs a direction-indicator function, which may in particular complement a sequential direction-indicator function performed by a tail lamp of the vehicle. Since the images 10a, 10b and 10c are projected onto the ground, in the vehicle's near field, they are thus able to be easily perceived by a road user driving on the right of the automotive vehicle. The sub-patterns produced by the windows 72 of the mask 7 from the images of the junction faces 52 of the light guides 5 may in particular be seen in FIG. 4.

It will be noted that to form other patterns, of different shapes and/or composed of a different number of sub-patterns, the primary optical system 4 may remain identical, and that all that is required is to modify the arrangement and/or the number of LEDs and/or to modify the shape and/or the number of zones 73 capable of letting light pass.

The above description clearly explains how the invention achieves the set objectives, namely providing a compact and efficient optical module allowing a complex pattern to be produced from a single light source, for example a pattern containing details within the pattern itself or even a pattern composed of a number of separate sub-patterns, and/or which allows the sharpness of the pattern projected onto the ground to be improved, the optical module combining a primary optical system capable of forming primary images from light sources and a mask capable of modifying these primary images to form secondary images.

In any event, the invention is not limited to the embodiments specifically described in this document, and extends, in particular, to any equivalent means and to any technically operational combination of these means. It is in particular possible to envision employing types of light sources other than those described. It is also possible to envision other shapes for the junction faces or for the windows of the mask. It is also possible to provide a primary optical system comprising a single primary optical member. It is also possible to envision types of primary optical members other than a light guide, and in particular collimators, lenses or microlenses, reflectors or combinations of various types of primary optical members. It is also possible to envision other embodiments of the mask. It is also possible to envision light-emitting functions other than those described, and in particular other functions for indicating a change of path of an automotive vehicle, such as a reversing indicator or a lane-change indicator, driver-assistance functions or inter-vehicle communication functions, or even functions for signaling a manual or autonomous driving mode.

What is claimed is:

1. An optical module for a light-emitting system for an automotive vehicle, comprising:
a. at least one light source ;
b. a one-piece primary optical system including at least one primary optical member, the primary optical member being arranged to form a primary image from the light source;
c. a mask placed downstream of said primary optical member and having at least one opaque zone and a window formed in the opaque zone, the window being arranged facing the primary optical member so as to form a secondary image from the primary image, a segment of the one-piece primary optical system extending through the window; and
d. a projecting optical system arranged to project, onto the ground, the secondary image formed by the mask.

2. The optical module as claimed in claim 1, wherein the primary optical system is produced by over-molding at least one material on the mask.

3. The optical module as claimed in claim 1, wherein the projecting optical system has a focal surface passing substantially through the mask or located substantially between the primary optical member and the mask.

4. The optical module as claimed in claim 1, wherein the at least one light source includes a plurality of selectively controllable light sources, the one-piece primary optical system includes a plurality of primary optical members, with each of the plurality of primary optical members being arranged to form a primary image from one of the light sources, and wherein the mask includes a plurality of windows each arranged facing one of the plurality of primary optical members so as to form a secondary image from the primary image formed by the plurality of primary optical members, with one segment of the one-piece primary optical system extending through each of the windows.

5. The optical module as claimed in claim 4, wherein the plurality of primary optical members are arranged in a matrix array.

6. The optical module as claimed in claim 1, wherein the primary optical system includes an exit optical member, the primary optical member includes an entrance face for light, facing which the light source is placed, and a junction face joining the primary optical member to the segment extending through the window, the segment being joined to the exit optical member.

7. The optical module as claimed in claim 6, wherein the junction face of the primary optical member and an upstream face of the mask lie substantially in the same plane.

8. The optical module as claimed in claim 7, wherein the primary optical member includes a primary light guide, the entrance face of the light guide being joined to the junction face of the light guide by an envelope such that each point on the outline of the entrance face is connected to one point on the outline of the junction face by a straight line.

9. The optical module as claimed in claim 8, wherein the projecting optical system has a focal surface passing substantially through the junction face where the primary optical member joins the segment.

10. A light-emitting system for an automotive vehicle, comprising an optical module, with the optical module including at least one light source, a one-piece primary optical system including at least one primary optical member, the primary optical member being arranged to form a primary image from the light source, a mask placed downstream of the primary optical member and having at least one opaque zone and a window formed in the opaque zone, the window being arranged facing the primary optical member so as to form a secondary image from the primary image, a segment of the one-piece primary optical system extending through the window, and a projecting optical system arranged to project, onto the ground, the secondary image formed by the mask.
